(19) United States
(12) Patent Application Publication
(10) Pub. No.: US 2025/0077821 A1
(43) Pub. Date: Mar. 6, 2025

(54) IMAGE FORMING APPARATUS, CONTROL METHOD, AND NON-TRANSITORY COMPUTER-READABLE RECORDING MEDIUM

(71) Applicant: Konica Minolta, Inc., Tokyo (JP)

(72) Inventors: Mitsuo AZUMAI, Hino-shi Tokyo (JP); Shinya ASAKURA, Hino-shi Tokyo (JP)

(21) Appl. No.: 18/816,117

(22) Filed: Aug. 27, 2024

(30) Foreign Application Priority Data
Aug. 29, 2023 (JP) 2023-139089

(51) Int. Cl. G06K 15/02; G06K 15/10

(52) U.S. Cl. CPC G06K 15/027; G06K 15/102

(57) ABSTRACT

An image forming apparatus includes: a recording head section in which multiple recording heads each provided with multiple ejection nozzles in a main scanning direction are arranged so as to partially overlapping each other in the main scanning direction, a switching section that switches, in an overlap region of the multiple recording heads in the main scanning direction, ejection nozzles that eject ink from among the multiple recording heads, a storage section that stores multiple correction data for equalizing density unevenness in the main scanning direction caused by each of the multiple recording heads; and a density correction that corrects density unevenness occurring in the overlap region based on the multiple pieces of correction data.

### CROSS REFERENCE TO RELATED APPLICATIONS

The present invention claims priority under 35 U.S.C. § 119 to Japanese Patent Application No. 2023-139089 filed on Aug. 29, 2023, the entire contents of which being incorporated herein by reference.

### BACKGROUND OF THE INVENTION

### Technical Field

The present invention relates to an image forming apparatus, a control method, a control apparatus, and a program. In particular, the present invention relates to an image forming technique in which multiple recording heads are used to increase the recording width in the main scanning direction.

### Description of Related Art

In an image forming apparatus using an inkjet recording method, an apparatus is known that uses multiple recording heads provided with multiple ejection nozzles in a main scanning direction and has a long recording width in the main scanning direction. In this type of image forming apparatus, the two recording heads are disposed with their ends overlapping each other in the main scanning direction. The image forming apparatus forms an image by ejecting ink from the ejection nozzles of one of the recording heads in the overlap region of the two recording heads.

Conventionally, a technique for making a joint between ink ejected from one recording head and ink ejected from the other recording head inconspicuous in an overlap region of the two recording heads has been proposed (for example, JP2003-165263A). In this conventional technology, the position of the joint of the ink ejected from each of the two recording heads is changed in the main scanning direction for each line. Thus, the ink joints can be dispersed in the main scanning direction. Therefore, the deterioration of the image quality in which the joint of the ink appears in one stripe shape along the sub-scanning direction is suppressed.

In addition, in the above-described conventional technology, it is also proposed to suppress deterioration in image quality due to a difference in ink ejection density between two adjacent print heads. That is, the above-described conventional technology proposes to read the density of a test output image and perform density correction (shading correction) for correcting the difference in ink ejection density.

However, in the density correction in the conventional technology, the value of the image data is converted based on the correction data in which the correction value is associated with each position in the main scanning direction regardless of the position of the joint of the ink ejected from each of the two recording heads. The correction value corresponding to each position in the main scanning direction is calculated based on a value obtained by averaging, in the sub-scanning direction, the densities of the test-output image. Therefore, the above-described conventional technology has a problem in that, at the joints of the ink ejected from each of the multiple recording heads, the density difference of the ink ejected from each recording head cannot be completely corrected and appears as density unevenness. Hereinafter, this problem will be specifically described.

FIG. 11A, FIG. 11B, FIG. 11C, FIG. 12A, and FIG. 12B illustrate the concept of density correction in the conventional technology. As illustrated in FIG. 11A, the two recording heads 101 and 102 are arranged along the main scanning direction X in a state in which end portions thereof overlapping each other. In the recording head 101, multiple ejection nozzles 103 are arranged along the main scanning direction X. In the recording head 102, multiple ejection nozzles 104 are arranged along the main scanning direction X. The nozzle diameters of the ejection nozzles 103 and 104 are not necessarily uniform because of inclusion of a manufacturing error or the like. Therefore, the amount of ink ejected from each of the ejection nozzles 103 and 104 is not constant. In the 11A of the drawing, “L” is appended to ejection nozzles having nozzle diameters larger than the standard size, “M” is appended to ejection nozzles of the standard size, and “S” is appended to ejection nozzles having nozzle diameters smaller than the standard size.

An ejection nozzle having a standard nozzle diameter ejects a predetermined amount of ink. In contrast, an ejection nozzle having a large nozzle diameter ejects an ink in an amount greater than the predetermined amount. Therefore, the density of a dot formed by ink ejected from an ejection nozzle having a large nozzle diameter becomes dark. An ejection nozzle having a small nozzle diameter ejects an ink smaller than the predetermined amount. Therefore, the density of a dot formed by ink ejected from an ejection nozzle having a small nozzle diameter is low.

In the conventional technology, in order to make the joint between the ink ejected from one of the recording heads and the ink ejected from the other recording head less conspicuous in the overlap region Rx of the two recording heads 101 and 102 as illustrated in the FIG. 11B, the joint positions Px of the ink ejected from the two recording heads 101 and 102 are switched to different positions in the main scanning direction X for each line based on the joint position data-item (division line shape data-item) 105. Thus, the ink connecting positions Px can be dispersed in the main scanning direction X.

Here, it is assumed that an image having a uniform density is formed by the two recording heads 101 and 102 as illustrated in FIG. 11B. In this case, since there is a difference in the ejection amount of ink ejected from each ejection nozzle, an image formed by the two recording heads 101 and 102 without performing density correction is an image as illustrated in FIG. 11C. In the image in FIG. 11C, density unevenness occurs based on the difference in the ejection amount of ink ejected from each of the ejection nozzles 103 and 104 along the main scanning direction X.

In the conventional technology, in order to correct the density unevenness, an image illustrated in a FIG. 11C is output as a test image, and the density of the test image is read. Then, the conventional technology generates a correction value at each position in the main scanning direction X based on the density read from the test image. Here, the image scanner for reading the density of the test image reads the density value averaged along the sub-scanning direction of the test image. Then, the conventional technology calculates a correction value at each position in the main scanning direction X based on the density value averaged in the sub-scanning direction. FIG. 12A illustrates a correction datum 106 in which correction values calculated in the conventional technology are recorded. When the density value averaged in the sub-scanning direction in the image in the FIG. 11C is the standard density, the compensation value is “0” in the compensation datum 106 in the FIG. 12A. Further, when the density value averaged in the sub-scanning direction in the image of FIG. 11C is higher than the standard density, the compensation value is “−1” in the compensation datum 106 of the 12A of the drawing. Furthermore, if the density value averaged in the sub-scanning direction is lighter than the standard density in the image of FIG. 11C, the compensation value is “+1” in the compensation datum 106 in FIG. 12A. In the conventional technology, density correction is performed based on correction values of one correction datum 106 illustrated in FIG. 12A.

However, as described above, the joining position Px of the ink ejected from each of multiple recording heads 101 and 102 is switched to another position in the main scanning direction X for each line based on the joining position data 105. In this case, even if the density correction is performed based on the correction values of one correction datum 106, dots 107 darker than the standard density and dots 108 lighter than the standard density appear in the overlap region Rx of the two recording heads 101 and 102 as illustrated in FIG. 12B. That is, the conventional technology cannot completely correct the density unevenness in the overlap region Rx of the two print heads 101 and 102. Therefore, the conventional technology still has a problem that image quality degradation due to density unevenness occurs.

### SUMMARY OF THE INVENTION

The present invention provides an image forming apparatus, a control method, and a non-transitory computer-readable recording medium that solve the above-described conventional problems. That is, an object of the present invention is to form a high-quality image by eliminating the occurrence of density unevenness in an overlap region of multiple recording heads.

In order to achieve the above objects, first, the present invention is directed to an image forming apparatus.

In one aspect of the present invention, the image forming apparatus includes a recording head section in which multiple recording heads each provided with multiple ejection nozzles in a main scanning direction are arranged so as to partially overlapping each other in the main scanning direction, a switching section that switches, in an overlap region of the multiple recording heads in the main scanning direction, ejection nozzles that eject ink from among the multiple recording heads, a storage section that stores the multiple correction data for equalizing density unevenness in the main scanning direction caused by each of the multiple recording heads, and a density correction that corrects density unevenness occurring in the overlap region based on the multiple pieces of correction data.

Second, the present invention is directed to a method of controlling an image forming apparatus in which multiple recording heads provided with multiple ejection nozzles in a main scanning direction are arranged in a state where parts of the recording heads overlapping each other in the main scanning direction.

In one aspect of the present invention, the control method includes: switching an ejection nozzle that ejects ink from among the multiple recording heads in an overlap region of the multiple recording heads in the main scanning direction; storing multiple correction data for equalizing density unevenness in the main scanning direction caused by each of the multiple recording heads; and correcting density unevenness generated in the overlap region is corrected based on the multiple correction data.

Third, the present invention is directed to a non-transitory computer-readable recording medium recording a program to be executed in an image forming apparatus including multiple recording heads provided with multiple ejection nozzles in a main scanning direction, the recording heads being arranged in the main scanning direction in a partially overlap manner.

In one aspect of the present invention, the program causes the image forming apparatus to execute: switching an ejection nozzle that ejects ink from among the multiple recording heads in an overlap region of the multiple recording heads in the main scanning direction; storing the multiple correction data for equalizing density unevenness in the main scanning direction caused by each of the multiple recording heads; and correcting density unevenness generated in the overlap region is corrected based on the multiple correction data.

### BRIEF DESCRIPTION OF THE DRAWINGS

The advantages and features provided by one or more embodiments of the invention will become more fully understood from the detailed description given herein below and the appended drawings which are given by way of illustration only, and thus are not intended as a definition of the limits of the present invention.

FIG. 1 is a schematic diagram illustrating an example of the configuration of an image forming apparatus.

FIG. 2 illustrates an ink ejection surface of a recording head section.

FIG. 3A illustrates an enlarged view of the overlap region of two print heads.

FIG. 3B illustrates a concept of switching a joining position.

FIG. 4 is a block diagram illustrating a configuration example of the control apparatus.

FIG. 5A, FIG. 5B, and FIG. 5C illustrate an example in which the correction date is generated by the test image by the first recording head.

FIG. 6A, FIG. 6B, and FIG. 6C illustrate examples of generating correction date by a test image by the second recording head.

FIG. 7A, FIG. 7B, and FIG. 7C illustrate a concept of density correction in an overlap region of two print heads.

FIG. 8 illustrate another configuration example of the control apparatus.

FIG. 9 is a flowchart illustrating an example of a processing procedure performed by the control apparatus.

FIG. 10 illustrate an example of a configuration in which four recording heads are arranged in the main scanning direction.

FIG. 11A, FIG. 11B, and FIG. 11C illustrate a concept of concentration correction in the conventional technology; and

FIG. 12A and FIG. 12B illustrate a concept of density correction in the conventional technology.

### DETAILED DESCRIPTION OF THE EMBODIMENTS

Hereinafter, one or more embodiments of the present invention will be described with reference to the drawings. However, the scope of the invention is not limited to the disclosed embodiments.

Hereinafter, preferred embodiments of the present invention will be described in detail with reference to the drawings. Note that elements common to the embodiments described below are denoted by the same reference signs, and redundant description thereof is omitted.

### First Embodiment

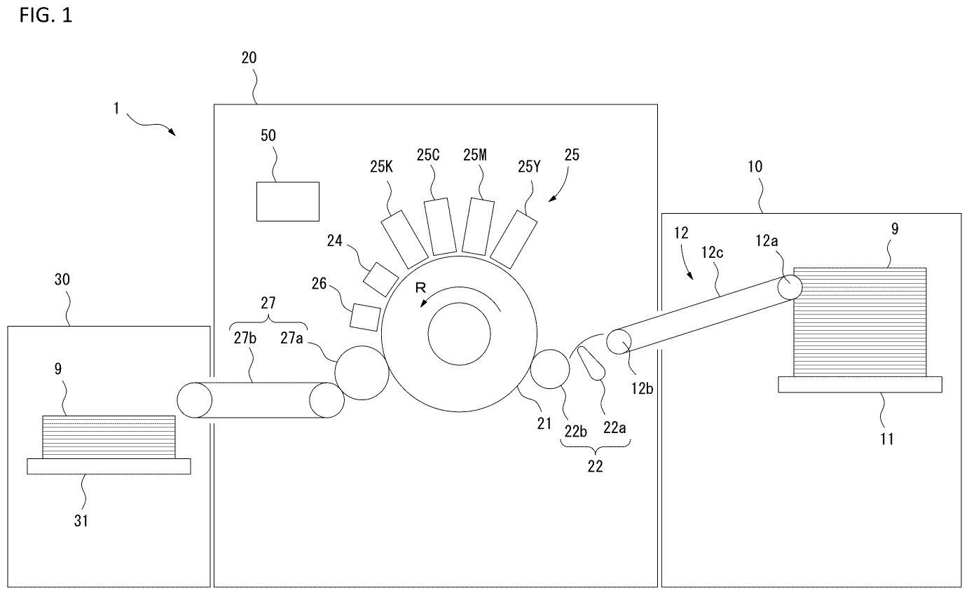

FIG. 1 is a schematic diagram illustrating a configuration example of an image forming apparatus 1 according to the first embodiment of the present disclosure. The image forming apparatus I conveys a sheet-like medium 9, such as a printing sheet, along a predetermined conveyance path. When the medium 9 passes a predetermined position, the image forming apparatus 1 forms an image on the medium 9 by an inkjet recording method. Note that FIG. 1 illustrates an apparatus capable of forming a color image on the medium 9 using four color inks of yellow (Y), magenta (M), cyan (C), and black (K).

As illustrated in FIG. 1, the image forming apparatus 1 includes a medium supply section 10, an image forming section 20, a medium ejection section 30, and a control apparatus 50. The image forming apparatus 1 is connected to an external terminal apparatus (not illustrated) via a network. The image forming apparatus 1 acquires print data to be printed from the terminal apparatus and forms an image on the medium 9.

The medium supply section 10 includes a medium tray 11 and a supply mechanism 12. The medium tray 11 is a plate-shaped member on which multiple sheets of medium 9 can be placed. The medium tray 11 is provided so as to be movable in the vertical direction in accordance with the number of medium 9 placed thereon. Among the multiple sheets of medium 9 placed on the medium tray 11, the uppermost medium 9 in the vertical direction is taken out one by one by the supply mechanism 12 and is transported along the transport path.

The feeding mechanism 12 includes two rollers 12a and 12b and a conveyor belt 12c. The conveyor belt 12c is formed as an endless belt in which both ends in the longitudinal direction are connected. The conveyor belt 12c is wound around two rollers 12a and 12b. When one of the two rollers 12a and 12b is driven to rotate, the conveyor belt 12c circulates between the two rollers 12a and 12b. Accordingly, one medium 9 placed on the conveyor belt 12c is transported toward the image forming section 20.

The image forming section 20 includes a medium holder 21, a handover unit 22, a printing unit 25, a fixing section 24, an image reader 26, and an ejection mechanism 27.

The medium holder 21 is formed as a cylindrical drum. The medium holder 21 is rotated in a direction of an arrow R by a drive motor (not illustrated). The outer peripheral surface of the medium holder 21 holds the medium 9 supplied from the medium supply section 10. For example, the medium 9 is held in a state of being attached to the outer circumferential surface of the medium holder 21. Therefore, the surface (outer peripheral surface) of the medium holder 21 functions as a medium holding surface for holding the medium 9. By rotating in the direction of arrow R, the medium holder 21 conveys the medium 9 along an arc-shaped conveyance path formed by the outer circumferential surface of the medium holder 21. A printing unit 25, a fixing section 24, and an image reading section 26 are disposed to face the outer circumferential surface of the medium holder 21.

The handover unit 22 is provided between the supply mechanism 12 of the medium supply section 10 and the medium holder 21. The handover unit 22 includes a claw portion 22a, a cylindrical handover drum 22b, and the like. The claw portion 22a carries one end of the medium 9 conveyed by the supply mechanism 12. The handover drum 22b guides the medium 9 borne on the claw portion 22a toward the medium holder 21. Thus, the medium 9 is delivered from the supply mechanism 12 to the outer peripheral surface of the medium holder 21 via the handover unit 22.

The printing unit 25 includes a recording head section 25Y, a recording head section 25M, a recording head section 25C, and a recording head section 25K in order from the upstream in the conveyance direction of the medium 9. The recording head section 25Y ejects a yellow (Y) ink. The recording head section 25M ejects magenta (M) ink. The recording head section 25C ejects cyan (C) ink. The recording head section 25K ejects black (K) ink.

The recording head sections 25Y, 25M, 24C, and 25K are set to have lengths (widths) that cover the entirety of the medium 9 in the axial direction of the medium holder 21 (the widthwise direction of the conveyance path). That is, the image forming apparatus 1 is a one pass line-head-type inkjet recording apparatus. The recording head sections 25Y, 25M, 25C, and 25K hold the inks of the respective colors in a melted state, and are driven by the control apparatus 50 to eject the melted inks toward the front face of the medium 9 conveyed by the medium holder 21. Note that the axial direction of the medium holder 21 corresponds to the main scanning direction X when an image is formed by each of the recording head sections 25Y, 25M, 25C, and 25K. Furthermore, the conveyance direction of the medium 9 corresponds to the sub-scanning direction Y in which an image is formed by the recording head sections 25Y, 25M, 25C, and 25K.

The fixing section 24 is disposed on the downstream side of the printing unit 25 in the transport direction of the medium 9. The fixing section 24 cures the ink ejected onto the medium 9 and fixes it to the medium 9. As such a fixing section 24, for example, one that irradiates the medium 9 with ultraviolet rays can be used.

An image reader 26 is provided on the downstream side of the fixing section 24 in the transport direction of the medium 9. For example, the image reader 26 is constituted by an image scanner. The image reader 26 reads the density of an image formed on the surface of the medium 9 by the printing unit 25. The image reader 26 includes multiple reading elements arranged along a main scanning direction X. For example, one reading element forms one pixel. Therefore, the image reader 26 reads the density of the image at the position of each pixel arranged along the main scanning direction X.

An ejection mechanism 27 is provided on the downstream side of the image reader 26 in the conveyance direction of the medium 9. The ejection mechanism 27 conveys the medium 9 transported by the medium holder 21 toward the medium ejection section 30. The ejection mechanism 27 includes a cylindrical separation drum 27a and an ejection belt 27b. The separation drum 27a separates the medium 9 held by the medium holder 21 from the outer peripheral surface of the medium holder 21. Then, the separation drum 27a guides the medium 9 to the ejection belt 27b. The ejection belt 27b is formed as an endless belt similarly to the conveyor belt 12c of the supply mechanism 12. The ejection belt 27b is rotatably supported by multiple rollers. The ejection belt 27b sends the medium 9 delivered from the separation drum 27a to the medium ejection section 30.

The medium ejection section 30 stores the medium 9 sent from the image forming section 20 by the ejection mechanism 27. The medium ejection section 30 includes a collection tray 31 having a flat plate shape. The medium ejection section 30 places the medium 9 having an image formed thereon on the collection tray 31.

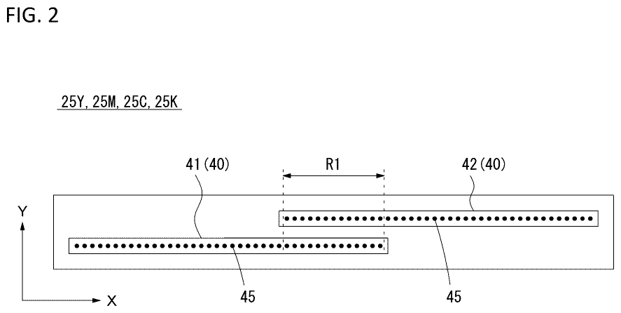

FIG. 2 iillustrate ink ejection surfaces of the recording head sections 25Y, 25M, 25C, and 25K. The ink ejection surfaces are surfaces of the recording head sections 25Y, 25M, 25C, and 25K that face the medium holder 21. As illustrated in FIG. 2, on the ink ejection surface of each of the recording head sections 25Y, 25M, 25C, and 25K, multiple recording heads 40 are arranged along the main scanning direction X. In FIG. 2, two recording heads 40 of a first recording head 41 and a second recording head 42 are arranged along the main scanning direction X. In each of the recording heads 41 and 42, multiple ejection nozzles 45 are arranged along the main scanning direction X. Each of the ejection nozzles 45 ejects ink toward a medium 9. In addition, the two recording heads 41 and 42 are arranged in a state where end portions thereof overlapping each other in the main scanning direction X. Therefore, the two recording heads 41 and 42 have an overlap region R1 that overlapping each other.

When forming an image on the medium 9, the controller 50 drives one of the two recording heads 41 and 42 in the overlap region R1 of the two recording heads 41 and 42, and forms an image for one line in the main scanning direction X.

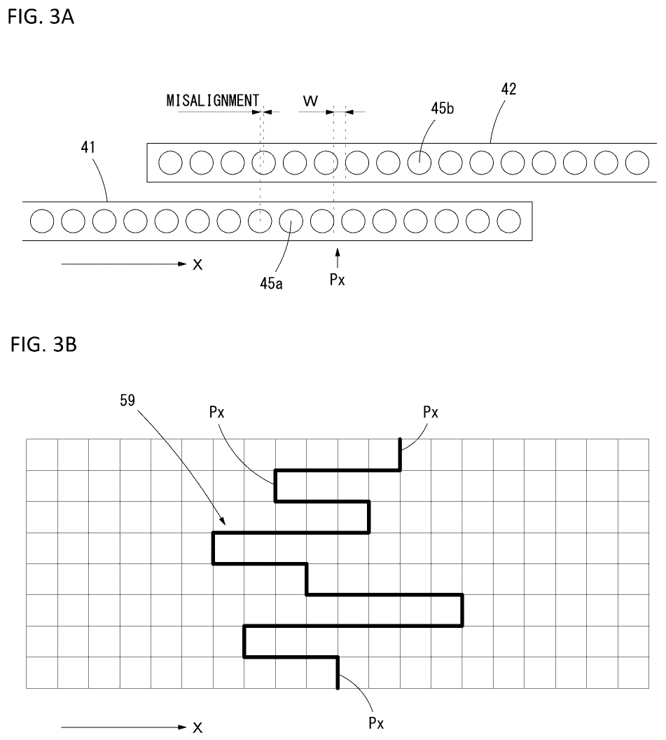

FIG. 3A is an enlarged view of an overlap region R1 between the two recording heads 41 and 42. For example, the controller 50 sets a predetermined position in the main scanning direction X in the overlap region R1 of the two recording heads 41 and 42 as the joining position Px. When forming an image on the left side of the joining position Px, the control apparatus 50 drives the ejection nozzles 45a of the first recording head 41 to form the image. Further, when forming an image on the right side of the joining position Px, the control apparatus 50 drives the ejection nozzles 45b of the second recording head 42 to form the image.

As illustrated in FIG. 3A, the positions of the ejection nozzles 45a of the recording head 41 and the positions of the ejection nozzles 45b of the recording head 42 do not necessarily coincide with each other in the main scanning direction X, and positional displacement may occur. Such a position shift occurs due to, for example, mounting errors of the recording heads 41 and 42 with respect to the recording head sections 25Y, 25M, 25C, and 25K. Therefore, it is difficult to eliminate the position shift. When the positional deviation occurs between the ejection nozzle 45a and the ejection nozzle 45b, the interval W at which the ink is ejected at the joining position Px is different from the interval at other portions. For example, when an image is formed in the sub-scanning direction with the joining positions Px being fixed, streaky lines corresponding to the intervals W appear in the image formed on the medium 9.

The control apparatus 50 prevents such a streaky line from appearing. That is, the control apparatus 50 sequentially switches the joining position Px of the two recording heads 41 and 42 to another position in the main scanning direction X for each line. FIG. 3B illustrates a concept of switching the connecting position Px. The control apparatus 50 switches the joining position Px in the main scanning direction X every time one line advances in the sub-scanning direction. As illustrated in FIG. 3B, the control apparatus 50 holds the joining position 59 for switching the joining position Px for each line. When forming an image of the overlap region R1 of the two recording heads 41 and 42, the control apparatus 50 switches the joining position Px of the two recording heads 41 and 42 to another position in the main scanning direction X for each line based on the joining position data 59. Accordingly, the joining positions Px of the two recording heads 41 and 42 are dispersed in the main scanning direction X. As a result, the joint between the ink ejected from the recording head 41 and the ink ejected from the recording head 42 becomes inconspicuous, and it is possible to prevent a streaky line from appearing in the image formed on the medium 9.

In addition, the control apparatus 50 has a configuration for eliminating density unevenness which occurs in the overlap region R1 of the two recording heads 41 and 42. Hereinafter, the control apparatus 50 will be described in detail.

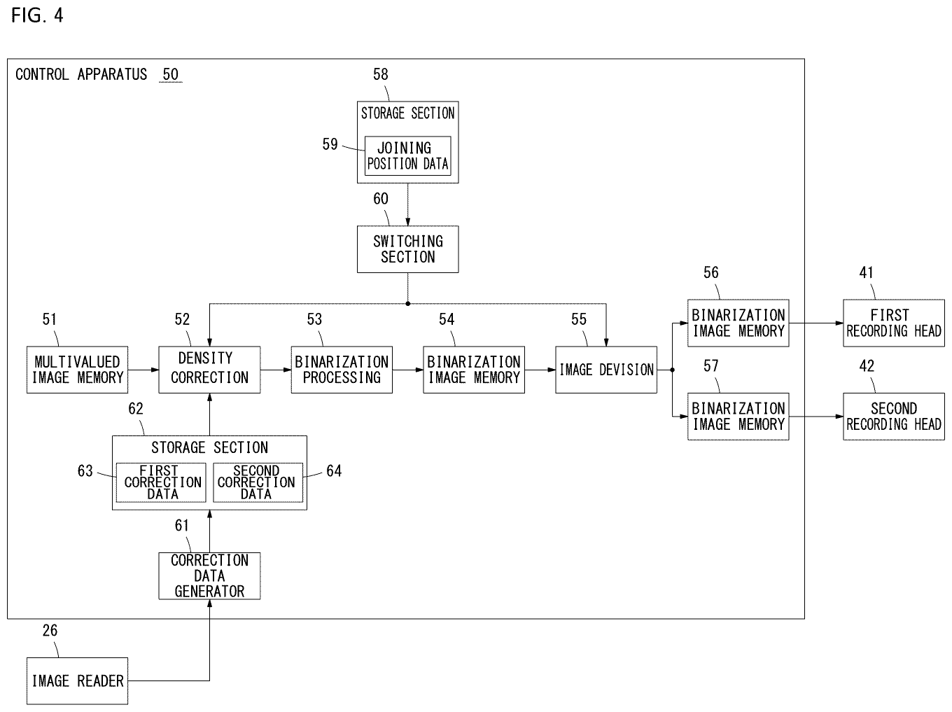

FIG. 4 illustrates a configuration example of the control apparatus 50. As illustrated in FIG. 4, the control apparatus 50 includes a multivalued image memory 51, a density correction 52, a binarization processing 53, a binarization image memory 54, an image division 55, a binarization image memory 56, a binarization image memory 57, a storage section 58, a switching section 60, a correction data generator 61, and a storage section 62. For example, the control apparatus 50 includes these sections as hardware.

The multivalued image memory 51 stores a multivalued image to be printed. The density correction 52 reads the multivalued image from the multivalued image memory 51 and corrects the density of each pixel. The binarization processing 53 binarizes the multivalued image output from the density correction 52 with a predetermined threshold value to generate a binary image. The binarization image memory 54 stores the binary image output from the binarization processing 53. The image division 55 divides the binary image stored in the binarization image memory 54 into an image to be recorded by the first recording head 41 and an image to be recorded by the second recording head 42. The binarization image memories 56 and 57 store the binary images divided by the image division 55. The binarization image memory 56 stores an image to be recorded by the first recording head 41. The binarization image memory 57 stores an image to be recorded by the second recording head 42.

The storage section 58 stores therein the connecting position information 59 illustrated in FIG. 3B. The switching section 60 switches the ejection nozzles 45 that ejects ink from the two recording heads 41 and 42 in the overlap region R1 of the two recording heads 41 and 42. The switching section 60 instructs the density correction 52 and the image division 55 on the connecting position Px based on the connecting position data 59 stored in the storage section 58. For example, every time a scanning line in the main scanning direction X advances by one line in the sub-scanning direction, the switching section 60 changes the joining position Px from a previous position to another position based on the joining position data 59.

The image division 55 divides the binary image in the binarization image memory 54 into two images based on the joining position Px designated by the switching section 60. That is, the image division 55 divides the binary image into a left image and a right image using the connecting position 59 illustrated in FIG. 3B as a dividing line. The image division 55 stores the left image in the binarization image memory 56 as an image to be recorded by the first recording head 41. The image division 55 stores the right image in the binarization image memory 57 as an image to be recorded by the second recording head 42. The control apparatus 50 outputs the binary images stored in the binarization image memories 56 and 57 to the first recording head 41 and the second recording head 42, respectively, and drives the first recording head 41 and the second recording head 42. Thus, an image in which the two images are joined together with the joining position Px defined by the joining position data 59 as a boundary is formed on the medium 9. That is, an image in which the image drawn with the ink ejected from the ejection nozzles 45a of the first recording head 41 and the image drawn with the ink ejected from the ejection nozzles 45b of the second recording head 42 are joined together is formed on the medium 9.

In order to eliminate density unevenness in the overlap region R1, the control apparatus 50 prints a test image when a print job is not executed in the image forming apparatus 1. At this time, the control apparatus 50 generates, for example, a test image in which the entire image is filled with a predetermined density (standard density). Then, the control apparatus 50 stores the test image in the multivalued image memory 51 and starts an operation for printing the test image. At the time of printing the test image, the density correction 52 outputs the test image to the binarization processing 53 without performing density correction thereon. A binarization processing 53 binarizes a test image and stores it in a binarization image memory 54. The image division 55 does not perform image division on the binarized test image when the test image is printed, and stores the entire binarized test image in each of the binarization image memories 56 and 57. The control apparatus 50 forms a test image on the medium 9 based on the test images stored in the binarization image memories 56 and 57. Hereinafter, a processing in which the control apparatus 50 prints a test image and generates correction data will be described.

First, the control apparatus 50 outputs the test image stored in the binarization image memory 56 to the first recording head 41 and drives all of the ejection nozzles 45a of the first recording head 41 to form the test image on the medium 9.

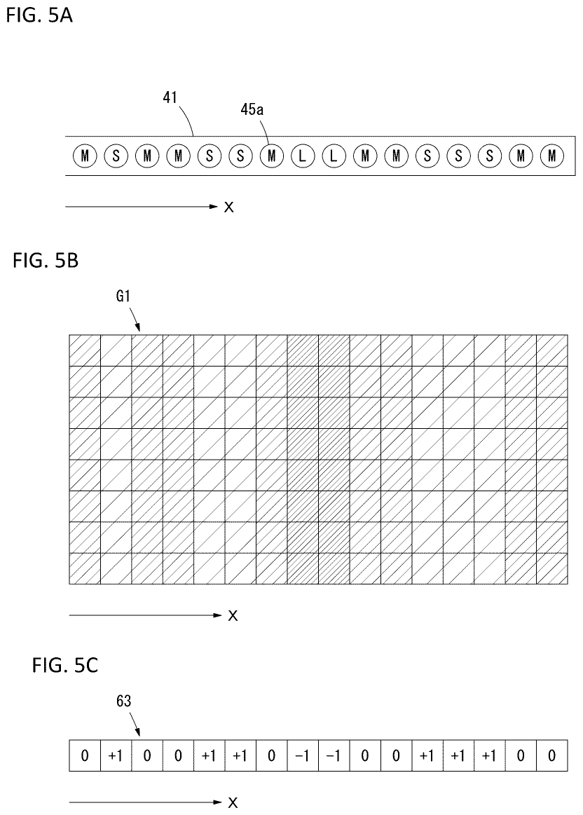

FIG. 5A, FIG. 5B, and FIG. 5C illustrate examples of printing of test images by the first recording head 41. As illustrated in FIG. 5A, in the first recording head 41, multiple ejection nozzles 45a are arranged along the main scanning direction X. The nozzle diameters of the ejection nozzles 45a are not necessarily uniform due to manufacturing errors and the like. Therefore, the ejection amount of ink ejected from each ejection nozzle 45a is not constant. In FIG. 5A, “L” is appended to an ejection nozzle 45a whose nozzle diameter is larger than the standard size, “M” is appended to an ejection nozzle 45a of the standard size, and “S” is appended to an ejection nozzle 45a whose nozzle diameter is smaller than the standard size. When the test image is printed by driving the first recording head 41 illustrated in FIG. 5A, the test image G1 becomes an image as illustrated in FIG. 5B. That is, the test image G1 is an image (first test image) including light and shade corresponding to the nozzle diameters of the respective ejection nozzles 45a arranged along the main scanning direction X.

When the test image G1 is printed on the medium 9, the control apparatus 50 drives the image reader 26 to read the density of the test image G1 formed on the medium 9. The image reader 26 reads the density of the test image G1 formed on the medium 9. For example, the image reader 26 reads the density of the ink ejected from each ejection nozzle 45a of the first recording head 41. At this time, the image reader 26 reads the density averaged in the sub-scanning direction as the density at each position in the main scanning direction X. That is, the image reader 26 reads the shading of the image in the main scanning direction X appearing in the test image G1 illustrated in FIG. 5B.

Subsequently, the control apparatus 50 causes the correction data generator 61 to function. Based on the density of the test image G1 read by the image reader 26, the correction data generator 61 generates first correction data 63 for correcting the density of the ink ejected from each ejection nozzle 45a of the first recording head 41. The first correction data 63 is data for uniforming density unevenness caused by the first recording head 41. FIG. 5C illustrates an example of the first correction table 63. The first correction data 63 includes correction values corresponding to the respective ejection nozzles 45a of the first recording head 41. For example, in a case where the density detected from the test image G1 is a predetermined density (standard density), the correction values of the ejection nozzles 45a that have ejected ink of the predetermined density are “0”. In addition, in a case where the density detected from the test image G1 is higher than the predetermined density (standard density), the correction values of the ejection nozzles 45a that have ejected the ink having the higher density are “−1”. The correction value “−1” is a value that decreases the density of an image. Further, when the density detected from the test image G1 is a density lighter than the predetermined density (standard density), the correction values of the ejection nozzles 45a that have ejected the ink of the lighter density are “+1”. The correction value “+1” is a value for increasing the density of an image. These correction values are determined as values capable of correcting the error of the nozzle diameter of the first recording head 41. Upon generating the first correction data 63 illustrated in FIG. 5C, the correction data generator 61 stores the first correction data 63 in the storage section 62.

Next, the control apparatus 50 outputs the test image stored in the binarization image memory 57 to the second recording head 42 and drives all of the ejection nozzles 45b of the second recording head 42 to form the test image on the medium 9.

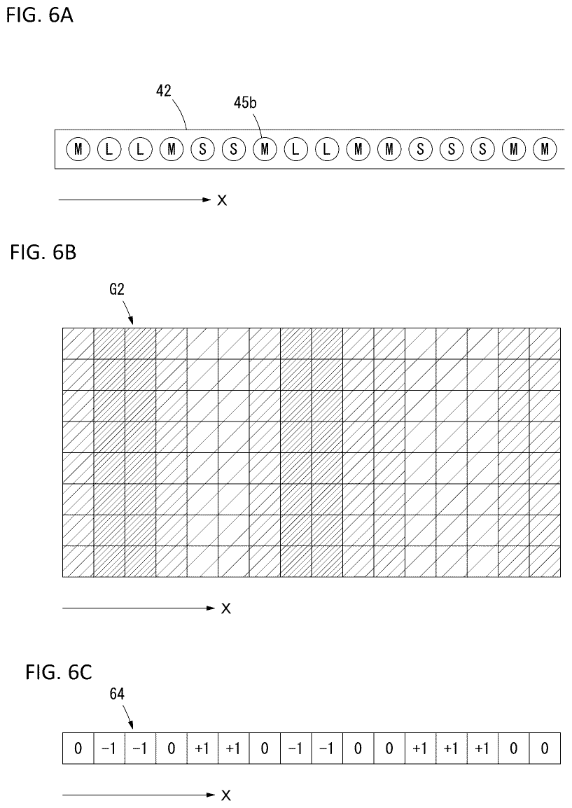

FIG. 6A, FIG. 6B, and FIG. 6C are diagrams illustrate examples of printing test images by the second recording head 42. As illustrated in FIG. 6A, multiple ejection nozzles 45b are arranged along the main scanning direction X in the second recording head 42. The nozzle diameters of the ejection nozzles 45b are not necessarily uniform due to manufacturing errors and the like. Therefore, the ejection amount of ink ejected from each ejection nozzle 45b is not constant. In FIG. 6A, “L” is appended to an ejection nozzle 45b whose nozzle diameter is larger than the standard size, “M” is appended to an ejection nozzle 45b of the standard size, and “S” is appended to an ejection nozzle 45b whose nozzle diameter is smaller than the standard size. When the second recording head 42 illustrated in FIG. 6A is driven to print a test image, the test image G2 becomes an image as illustrated in FIG. 6B. That is, the test image G2 is an image (second test image) including light and shade corresponding to the nozzle diameters of the respective ejection nozzles 45b arranged along the main scanning direction X.

When the test image G2 is printed on the medium 9, the control apparatus 50 drives the image reader 26 to read the density of the test image G2 formed on the medium 9. The image reader 26 reads the density of the test image G2 formed on the medium 9. For example, the image reader 26 reads the density of the ink ejected from each ejection nozzle 45b of the second recording head 42. At this time, the image reader 26 reads the density averaged in the sub-scanning direction as the density at each position in the main scanning direction X. That is, the image reader 26 reads the density of the image in the main scanning direction X appearing in the test image G2 illustrated in FIG. 6B.

Subsequently, the control apparatus 50 causes the correction data generator 61 to function. Based on the density of the test image G2 read by the image reading section 26, the correction data generator 61 generates the second correction data 64 for correcting the density of the ink ejected from each ejection nozzle 45b of the second recording head 42. The second correction data 64 is data for making density unevenness generated by the second recording head 42 uniform. FIG. 6C illustrates an example of the second correction data 64. The second correction data 64 includes correction values corresponding to the respective ejection nozzles 45b of the second recording head 42. For example, when the density detected from the test image G2 is a predetermined density (standard density), the correction values of the ejection nozzles 45b that have ejected ink of the predetermined density are “0”. In addition, in a case where the density detected from the test image G2 is higher than the predetermined density (standard density), the correction values of the ejection nozzles 45b that have ejected the ink having the higher density are “−1”. The correction value “−1” is a value that decreases the density of an image. Further, when the density detected from the test image G2 is a density lighter than the predetermined density (standard density), the correction values of the ejection nozzles 45b that have ejected the ink of the lighter density are “+1”. The correction value “+1” is a value for increasing the density of an image. These correction values are determined as values capable of correcting the error of the nozzle diameter of the second recording head 42. Upon generating the second correction data 64 illustrated in FIG. 6C, the correction data generator 61 stores the second correction data 64 in the storage section 62.

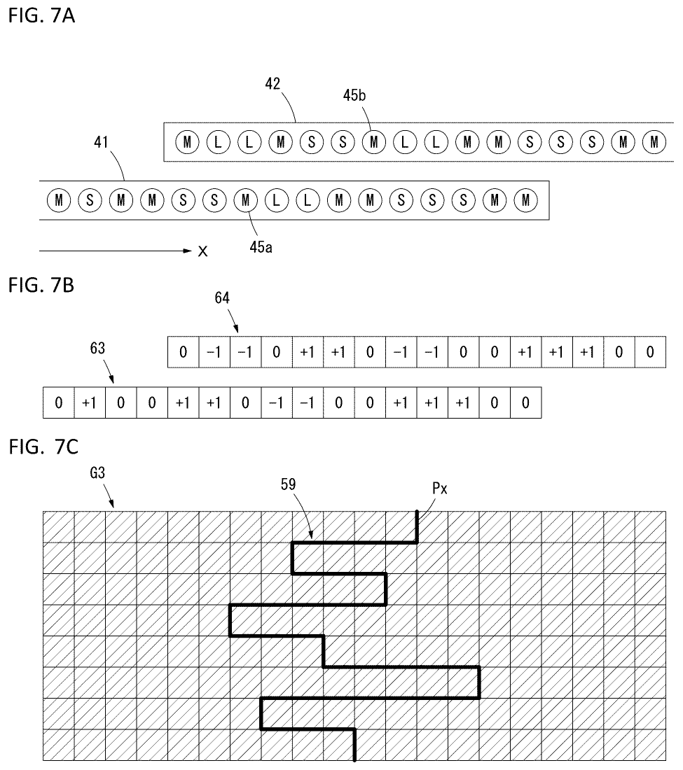

Next, density correction when a print job is executed in the image forming apparatus 1 will be described. FIG. 7A, FIG. 7B, and FIG. 7C illustrate a concept of density correction in the overlap region R1 of the two recording heads 41 and 42. When a print job is executed in the image forming apparatus 1, the control apparatus 50 drives the ejection nozzles 45a or 45b of one of the two recording heads 41, 42 to eject ink in the overlap region R1 of the two recording heads 41, 42 illustrated in FIG. 7A. At this time, a first correction datum 63 and a second correction datum 64 as illustrated in FIG. 7B are already stored in the storage section 62. When the density correction 52 reads the multivalued image to be printed from the multivalued image memory 51 and performs the density correction of each pixel, the density correction 52 selects one of the first correction datum 63 and the second correction datum 64 based on the joining position Px (see FIG. 7C) instructed from the switching section 60 and performs the density correction on the multivalued image.

The density correction 52 specifies whether the ink for each pixel included in the multivalued image is ejected from the ejection nozzle 45a of the first recording head 41 or the ejection nozzle 45b of the second recording head 42 based on the joining position Px instructed from the switching section 60. The density correction 52 performs the density correction using the correction value recorded in the first correction data 63 when performing the density correction of the pixel to which the ink is ejected from the first recording head 41. In addition, the density correction 52 performs the density correction using the correction value recorded in the second correction data 64 when performing the density correction of the pixel to which the ink is ejected from the second recording head 42. Thus, the density of the ink ejected from the first recording head 41 in the overlap region R1 between the two recording heads 41 and 42 can be corrected based on the correction values of the first correction information 63. In addition, the density of the ink ejected from the second recording head 42 can be corrected based on the correction value of the second correction data 64. The density correction 52 performs the above described density correction for each line in the main scanning direction X. As a result, the image G3 formed in the overlap region R1 of the two recording heads 41 and 42 becomes an image without density unevenness as illustrated in FIG. 7C. That is, even when the connecting position Px is switched for each line in the main scanning direction X, density unevenness does not occur in the image G3 formed on the medium 9 by a print job.

As described above, the image forming apparatus 1 of the present embodiment includes the recording head sections 25Y, 25M, 25C, and 25K which have the mutiple recording heads 41 and 42 provided with mutiple ejection nozzles 45 in the main scanning direction X and in which the mutiple of recording heads 41 and 42 are arranged in the main scanning direction X in a partially overlap manner. The image forming apparatus 1 includes the switching section 60 that switches the ejection nozzles 45 to eject ink from among the mutiple recording heads 41 and 42 in an overlap region R1 of the mutiple recording heads 41 and 42 in the main scanning direction X. The image forming apparatus 1 includes the storage section 62 storing the mutiple correction data 63 and 64 for equalizing density unevenness in the main scanning direction X by each of the mutiple recording heads 41 and 42. These multiple correction data 63 and 64 correspond to the multiple recording heads 41 and 42, respectively. The image forming apparatus 1 includes the density correction 52 that corrects the density unevenness occurring in the overlap region R1 based on the multiple correction data 63 and 64. The image forming apparatus 1 having such a configuration can correct density unevenness occurring in the overlap region R1 based on the multiple correction data 63 and 64. Therefore, the image forming apparatus 1 according to the present embodiment can appropriately eliminate the density unevenness that cannot be eliminated by one correction datum 106 (see 12A in FIG. 1) as in the conventional technology.

The switching section 60 according to the present embodiment selects the ejection nozzles 45 for ejecting ink from among the multiple recording heads 41 and 42 based on the joining position data 59 defining the joining positions Px in the main scanning direction X. The density correction 52 selects correction data to be used for correcting the density unevenness from among the multiple correction data 63 and 64 based on the joining position data 59. The image forming apparatus 1 having such a configuration can select the correction data 63 and 64 corresponding to the recording heads 41 and 42, from among the multiple recording heads 41 and 42, from which ink is ejected, to perform density measurement. Therefore, the image forming apparatus 1 according to the present embodiment can appropriately perform density correction in the overlap region R1, thereby suppressing the occurrence of density unevenness.

The switching section 60 according to the present embodiment selects the ejection nozzles 45 that eject ink for each predetermined line in the main scanning direction X, based on the joining position data 59. The density correction 52 changes the selection state of the correction data to be used for correcting the density unevenness from among the multiple correction data 63 and 64 for each predetermined line based on the joining position data 59. The image forming apparatus 1 having such a configuration can also change the correction data used in correcting the density unevenness with the switching of the ejection nozzles 45 for each predetermined line. Therefore, the image forming apparatus 1 according to the present embodiment can always perform appropriate density correction in the overlap region R1.

In the image forming apparatus 1 of the present embodiment, when the test images G1 and G2 having a predetermined density are printed by driving the multiple recording heads 41 and 42, the control apparatus 50 functions as a test image print section. The image forming apparatus 1 further includes an image reader 26 for reading the densities of the test images G1 and G2 and a correction data generator 61 for generating the multiple correction datas 63 and 64 based on the densities read by the image reader 26. Therefore, it is possible to generate the multiple correction data 63 and 64 for individually correcting the density unevenness of the ink ejected from each of the recording heads 41 and 42. By generating the multiple correction data 63 and 64 before executing the print job, the image forming apparatus 1 can appropriately correct the density unevenness using the multiple correction data 63 and 64 at the time of executing the print job.

Further, the control apparatus 50 may execute the printing of each of the test images G1 and G2 multiple times under different conditions to generate multiple sets of combinations of correction data 63 and 64. In this case, multiple combinations of the first correction data 63 and the second correction data 64 are stored in the storage section 62. Then, at the time of execution of the print job, the density correction 52 can perform more appropriate density correction by selecting, from among the multiple combinations of the first correction data 63 and the second correction data 64, the combination of the correction data 63 and 64 generated under the same conditions as the conditions under which the print job is executed.

For example, the state of the ejection nozzle 45 may change depending on the time zone of a day. In order to cope with such a change in the state of the ejection nozzles 45, the control apparatus 50 prints the test images G1 and G2 multiple times at different times. The image reader 26 reads the density of the test images G1 and G2 every time the test images G1 and G2 are printed by the control apparatus 50. The correction data generator 61 generates multiple sets of combinations of multiple correction data 63 and 64 based on the results of multiple density reading by the image reader 26. Next, when a print job is executed in the image forming apparatus 1, the density correction 52 selects, from among the multiple sets of correction data 63 and 64, a combination of correction data 63 and 64 generated at a time closest to the time of execution of the print job and performs density correction. Thus, the density correction suitable for the state of the ejection nozzles 45 at the time of execution of the print job is performed. Therefore, the density unevenness in the overlap region R1 is appropriately eliminated.

### Second Embodiment

Next, a second embodiment of the present invention will be described. In the first embodiment, a case where each section of the control apparatus 50 is configured by hardware has been exemplified. In the present embodiment, a configuration example in which each section of the control apparatus 50 described in the first embodiment is realized by software will be described.

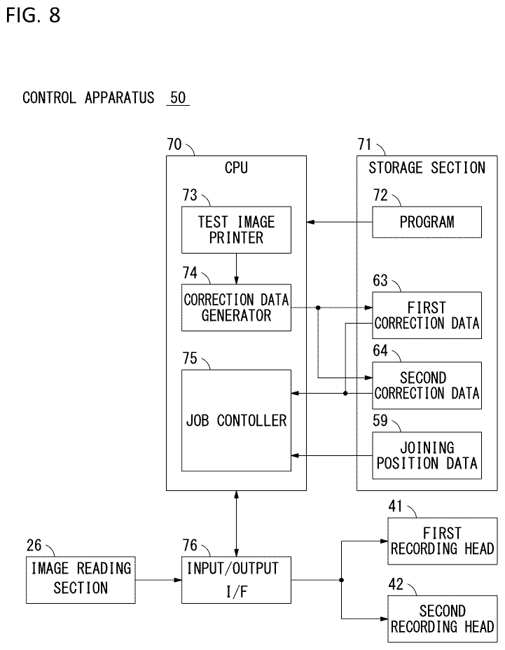

FIG. 8 illustrates a configuration example of the control apparatus 50 according to the second embodiment. The control apparatus 50 includes a CPU70, a storage section 71, and an input/output interface 76. The CPU70 is a hardware processor that reads and executes the program 72 stored in the storage section 71. The storage section 71 is a storage device including a hard disk drive (HDD) or a solid state drive (SSD). The storage section 71 stores the first correction data 63, the second correction data 64, and the joining position data 59 in addition to the program 72. The first recording head 41, the second recording head 42, and the image reader 26 are connected to the input/output interface 76. The CPU70 drives the first recording head 41 and the second recording head 42 via the input/output interface 76 and acquires the densities of the test images G1 and G2 read by the image reader 26.

The CPU 70 functions as a test image printer 73, a correction data generator 74, and a job controller 75 by executing the program 72. The test image printer 73 and the correction data generator 74 function when a print job is not executed in the image forming apparatus 1 and store the first correction data 63 and the second correction data 64 in the storage section 71. The job controller 75 functions when a print job is executed in the image forming apparatus 1. The job controller 75 has functions as the density correction 52, the binarization processing 53, the image division 55, and the switching section 60 described in the first embodiment. The storage section 71 has functions as the multivalued image memory 51, the binarization image memory 54, the binarization image memory 56, the binarization image memory 57, the storage section 58, and the storage section 62 described in the first embodiment.

The test image printer 73 sequentially forms the test images G1 and G2 on the medium 9 by driving each of the recording heads 41 and 42 when no print job is executed in the image forming apparatus 1.

As the test images G1 and G2 are sequentially formed on the medium 9 by the test image printer 73, the correction data generator 74 drives the image reader 26 and acquires the densities of the test images G1 and G2 read by the image reader 26. When acquiring the density of the test image G1, the correction data generator 74 calculates correction values for correcting the density of the ink ejected from each ejection nozzle 45a of the first recording head 41 and generates the first correction data 63. When the correction data generator 74 acquires the density of the test image G2, the correction data generator 74 calculates correction values for correcting the density of the ink ejected from the ejection nozzles 45b of the second recording head 42 and generates the second correction data 64. Then, the correction data generator 74 stores the first correction data 63 and the second correction data 64 in the storage section 71.

The job controller 75 acquires the multivalued image included in the print job specified by the user and performs density correction on the multivalued image. At this time, the job controller 75 functions as the density correction 52. The density correction 52 specifies, based on the connecting positions Px defined in the connecting position data 59, whether the ink for each pixel included in the multivalued image is ejected from the ejection nozzles 45a of the first recording head 41 or from the ejection nozzles 45b of the second recording head 42. When performing the density correction of the pixels to which the ink is ejected from the first recording head 41, the density correction 52 performs the density correction on the multivalued image by using the correction value recorded in the first correction data 63. In addition, when the density correction 52 performs the density correction of the pixel to which the ink is ejected from the second recording head 42, the density correction 52 performs the density correction on the multivalued image using the correction value recorded in the second correction data 64. Thus, the density of the ink ejected from the first recording head 41 in the overlap region R1 between the two recording heads 41 and 42 can be corrected based on the correction values of the first correction information 63. In addition, the density of the ink ejected from the second recording head 42 can be corrected based on the correction value of the second correction data 64. The density correction 52 performs the above described density correction for each line in the main scanning direction X. As a result, the image G3 formed in the overlap region R1 of the two recording heads 41 and 42 becomes an image without density unevenness as illustrated in FIG. 7C.

After performing the density correction on the multivalued image, the job controller 75 functions as the binarization processing 53. The binarization processing 53 converts the density corrected multivalued image into a binary image. After converting the multivalued image into the binary image, the job controller 75 functions as the image division 55. The image division 55 divides the binary image into two images based on the joining position Px instructed from the switching section 60. That is, the image division 55 divides the image into the image formed with the ink by the first recording head 41 and the image formed with the ink by the second recording head 42. Then, the job controller 75 drives each of the first recording head 41 and the second recording head 42 based on the two divided images to form an image on the medium 9.

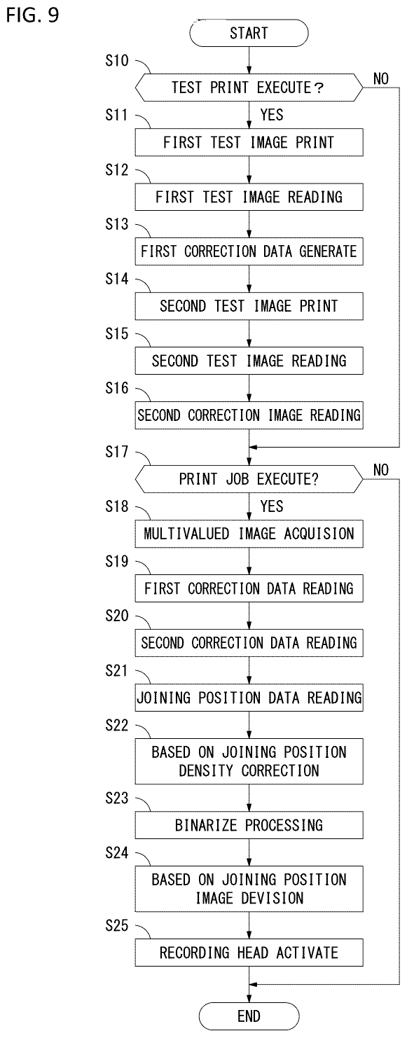

FIG. 9 is a flowchart illustrating an example of a processing procedure performed by the CPU70 of the control apparatus 50. The CPU70 sequentially executes processing based on the flowchart illustrated in FIG. 9 by executing the program 72.

Upon start of the process, the control apparatus 50 determines whether or not it is time to perform test printing (step S10). For example, at a predetermined time every day, the control apparatus 50 determines that it is the timing to execute the test printing. The predetermined time includes, for example, 9:00, 13:00, 15:00, and 18:00. Further, the control apparatus 50 determines that it is the timing to execute the test printing, for example, after a large amount of printing of a predetermined number of sheets or more is performed in the image forming apparatus 1. After the large volume printing, the state of the ejection nozzles 45 may become different from the previous state. For this reason, the control apparatus 50 may determine to execute the test printing after a large amount of printing of a predetermined number of sheets or more.

When the control apparatus 50 determines to execute the test printing (YES in step S10), the control apparatus 50 drives the first recording head 41 to print the first test image G1 on the medium 9 (step S11). The control apparatus 50 drives the image reading section 26 to read the first test image G1 formed on the medium 9 (step S12) and generates the first correction information 63 based on the density at each position in the main scanning direction X in the first test image G1 (step S13). The control apparatus 50 stores the first correction data 63 in the storage section 62.

Subsequently, the control apparatus 50 drives the second recording head 42 to print the second test image G2 on the medium 9 (step S14). The control apparatus 50 drives the image reading section 26 to read the second test image G2 formed on the medium 9 (step S15) and generates the second correction value 64 based on the density at each position in the main scanning direction X in the second test image G2 (step S16). The control apparatus 50 stores the second correction data 64 in the storage section 62.

Thus, the test printing processing ends. Note that when determining that it is not timing to perform test printing (NO in step S10), the control apparatus 50 does not perform the processing of steps S11 to S16.

Next, the control apparatus 50 determines whether or not to execute the print job (step S17). When it is determined that the print job is to be executed (YES in step S17), the control apparatus 50 acquires a multivalued image included in the print job (step S18). The control apparatus 50 reads the first correction data 63 from the storage section 62 (step S19). In addition, the control apparatus 50 reads the second correction datum 64 (step S20). Further, the control apparatus 50 reads the joining position 59 from the storage section 58 (step S21). Then, the control apparatus 50 selects either the first correction datum 63 or the second correction datum 64 based on the joining position datum 59 and corrects the density of the multi-value image (step S22).

Subsequently, the control apparatus 50 binarizes the density-corrected multivalued image (step S23) and divides the binarized image into two images based on the joining position Px of the joining position 59 (step S24). Then, the control apparatus 50 drives each of the first recording head 41 and the second recording head 42 based on the two divided images to form an image on the medium 9 (step S25). Note that in a case where the print job includes images for multiple pages, the processing of steps S18 to S25 are repeatedly executed according to the number of pages. If the print job is not to be executed (NO in step S17), the control apparatus 50 does not perform processing in steps S18 to S25. Thus, the processing by the control apparatus 50 is completed.

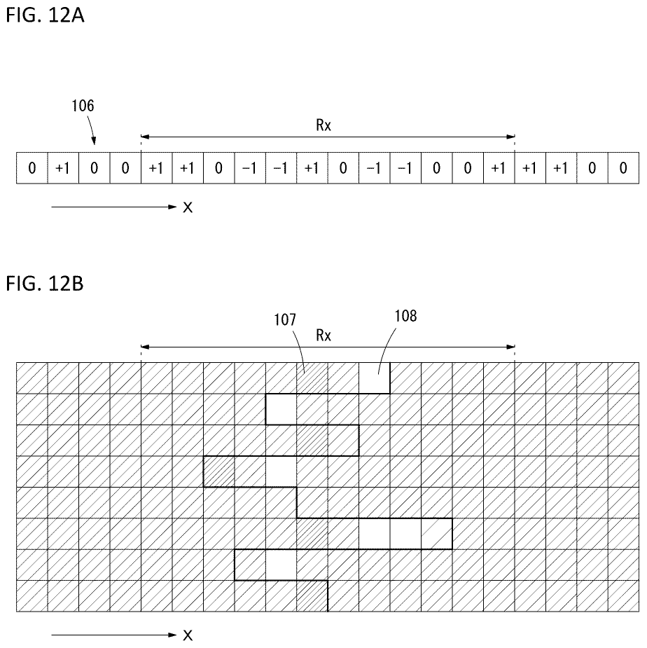

As in the first embodiment, the control apparatus 50 of the image forming apparatus 1 can appropriately eliminate density unevenness that cannot be eliminated by one correction datum 106 (see FIG. 12A) as in the conventional technology, by executing the processing as described above. Further, similarly to the first embodiment, the image forming apparatus 1 of the present embodiment can appropriately perform the density correction in the overlap region R1, so that the occurrence of the density unevenness can be suppressed. As described above, the image forming apparatus 1 of the present embodiment executes the operation of the control apparatus 50 described in the first embodiment by software and achieves the same effects as those of the first embodiment.

Note that the present embodiment is the same as the contents described in the first embodiment except for the points described above.

### Modification Example

A preferred embodiment of the present invention has been described above. However, the present invention is not limited to the content described in the above embodiment. Various modification examples other than the embodiment described above are applicable to the present invention.

For example, in the above-described embodiment, the image forming apparatus 1 in which the two recording heads 41 and 42 are arranged in the main scanning direction X in the recording head sections 25Y, 25M, 25C, and 25K has been described. However, the number of recording heads 40 arranged in the main scanning direction X in the recording head sections 25Y, 25M, 25C, and 25K is not limited to two. For example, each of the recording head sections 25Y, 25M, 25C, and 25K may have a configuration in which three or more recording heads 40 are arranged in the main scanning direction X.

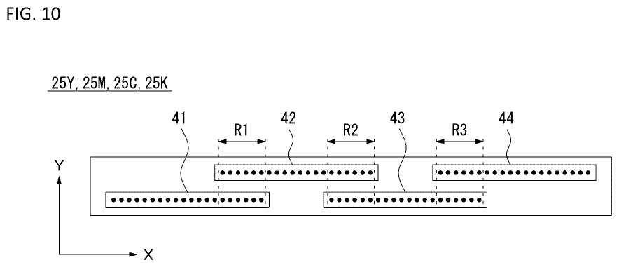

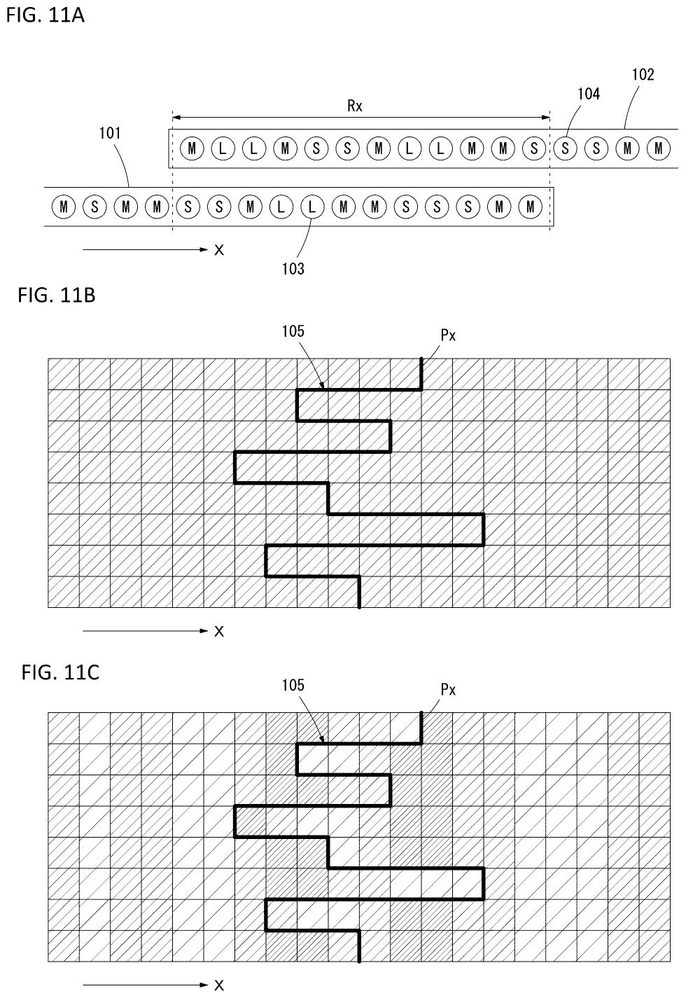

FIG. 10 illustrates a configuration example in which four recording heads 41, 42, 43, and 44 are arranged in the main scanning direction X. The recording head sections 25Y, 25M, 25C, and 25K illustrated in FIG. 10 include an overlap region R1 in which the recording head 41 and the recording head 42 overlapping each other, an overlap region R2 in which the recording head 42 and the recording head 43 overlapping each other, and an overlap region R3 in which the recording head 43 and the recording head 44 overlapping each other. Therefore, density unevenness may occur in each of the multiple overlap regions R1, R2, and R3. Therefore, the control apparatus 50 applies the above-described processing to each of the multiple overlap regions R1, R2, and R3 so as not to cause the density unevenness.

For example, when printing the test images G1 and G2, the control apparatus 50 simultaneously drives the odd numbered recording heads 41 and 43 in the main scanning direction X to form two test images G1 on the medium 9, and then simultaneously drives the even numbered recording heads 42 and 44 in the main scanning direction X to form two test images G2 on the medium 9. The test image G1 formed by the recording head 41 and the test image G1 formed by the recording head 43 do not overlapping each other on the surface of the medium 9. Therefore, the image reader 26 can simultaneously read the densities of the two test images G1. Similarly, the test image G2 formed by the recording head 42 and the test image G2 formed by the recording head 44 do not overlapping each other on the surface of the medium 9. Therefore, the image reader 26 can simultaneously read the densities of the two test images G2. Therefore, when printing the test image, the control apparatus 50 can efficiently generate the correction data 63 and 64 by driving the odd numbered recording heads 41 and 43 and the even numbered recording heads 42 and 44 at different timings.

In addition, in the first embodiment, an example in which the control apparatus 50 is configured by hardware has been described, and in the second embodiment, an example in which each function of the control apparatus 50 is realized by software has been described. However, in the present invention, the above-described functions of the control apparatus 50 are not limited to those configured by only one of hardware and software. That is, the functions of the control apparatus 50 may be configured by combining hardware and software.

In the above described embodiment, an example in which the switching section 60 switches the joining position Px for each line in the main scanning direction X has been mainly described. However, the switching of the connecting position Px by the switching section 60 may be performed every two lines in the main scanning direction X or every predetermined number of lines, which is three or more lines.

Further, in the above described embodiment, the case where the image forming apparatus 1 is an apparatus capable of forming a color image has been exemplified. However, the image forming apparatus 1 is not limited to an apparatus capable of forming a color image. That is, the image forming apparatus 1 may be an apparatus that forms an image in a single color of only K (black), for example.

Further, the program 72 described in the second embodiment is not limited to a program stored in advance in the storage section 71 of the image forming apparatus 1. For example, the program 72 may be a transaction target by itself. In this case, the program 72 may be provided in a downloadable form via a network such as the Internet, or may be provided in a state of being recorded on a computer-readable recording medium such as a CD-ROM.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image forming apparatus, comprising:
a recording head section in which multiple recording heads each provided with multiple ejection nozzles in a main scanning direction are arranged so as to partially overlapping each other in the main scanning direction,
a switching section that switches, in an overlap region of the multiple recording heads in the main scanning direction, ejection nozzles that eject ink from among the multiple recording heads,
a storage section that stores multiple correction data for equalizing density unevenness in the main scanning direction caused by each of the multiple recording heads; and
a density correction that corrects density unevenness occurring in the overlap region based on the multiple pieces of correction data.

2. The image forming apparatus according to claim 1, wherein
the switching section selects ejection nozzles for ejecting ink from among the multiple recording heads, based on joining position data defining joining positions in the main scanning direction, and
the density correction selects, based on the joining position data, correction data to be used for correcting the density unevenness from among the multiple correction data.

3. The image forming apparatus according to claim 2, wherein
the switching section selects an ejection nozzle to eject ink for each predetermined line in the main scanning direction based on the joining position data, and
the density correction changes, for each of the predetermined lines, selection of correction data to be used for correcting density unevenness from among the multiple correction data based on the joining position data.

4. The image forming apparatus according to claim 1, further comprising:
a test image printer that drives the multiple recording heads to print a test image having a predetermined density;
an image reader that reads a density of the test image; and
a correction data generator that generates the multiple correction data based on the density read by the image reader.

5. The image forming apparatus according to claim 4, wherein
the test image printer causes each of the multiple recording heads to print the test image by driving the multiple recording heads individually and
the image reader reads multiple test images formed by each of the multiple recording heads, and
the correction data generator generates the multiple correction data based on the density read from each of the multiple test images.

6. The image forming apparatus according to claim 4, wherein
the test image printer prints the test image multiple times under mutually different conditions, and
the image reader reads a density of the test image each time the test image is printed by the test image printer,
the correction data generator generates multiple sets of the multiple correction data combinations based on multiple density reading results obtained by the image reader, and
the density correction selects a combination of the multiple correction data generated under the same condition as a condition when a print job is executed among the multiple sets of the multiple correction data.

7. The image forming apparatus according to claim 4, wherein
the test image printer prints the test image multiple times at different times, and
the image reader reads a density of the test image each time the test image is printed by the test image printer,
the correction data generator generates multiple sets of the multiple correction data combinations based on the multiple density reading results obtained by the image reader, and
the density correction selects a combination of the multiple correction data generated at a time closest to a time when a print job is executed among the multiple sets of the multiple correction data.

8. The image forming apparatus according to claim 1, wherein
the multiple recording heads include a first recording head and a second recording head, and
the multiple correction data include a first correction data for uniforming the density unevenness of the first recording head and a second correction data for uniforming the density unevenness of the second recording head, and
the density correction corrects the density unevenness based on the first correction data when the ink is ejected from the ejection nozzles of the first recording head by the switching section and corrects the density unevenness based on the second correction data when the ink is ejected from the ejection nozzles of the second recording head by the switching section.

9. The image forming apparatus accordng to claim 8, further comprising:
a test image printer that drives the first recording head to print a first test image having a predetermined density and drive the second recording head to print a second test image having a predetermined density;
an image reader that reads a density of each of the first test image and the second test image; and
a correction data generator that generates the first correction data based on the density of the first test image read by the image reader and generates the second correction data based on the density of the second test image read by the image reader.

10. A control method for an image forming apparatus in which multiple recording heads provided with multiple ejection nozzles in a main scanning direction are arranged in a partially overlap state in the main scanning direction, comprising:
switching an ejection nozzle that ejects ink from among multiple recording heads in an overlap region of the multiple recording heads in the main scanning direction;
storing multiple correction data for equalizing density unevenness in the main scanning direction caused by each of the multiple recording heads; and
correcting density unevenness generated in the overlap region based on the multiple correction data.

11. The control method according to claim 10, wherein
when switching said ejection nozzles, selecting the ejection nozzle that ejects ink from multiple recording heads based on the joining position data that defines the joining position in the main scanning direction, and
when the density unevenness is corrected, electing correction data to be used to correct density unevenness from among the multiple correction data based on the joining position data.

12. The control method according to claim 11, wherein
when the ejection nozzles are switched, selecting an ejection nozzle to eject ink for each predetermined line in the main scanning direction based on the joining position data, and
when the density unevenness is corrected, changing the selection of correction data used to correct density unevenness from among the plurality of correction data for each predetermined line based on the joining position data.

13. The control method according to claim 10, further comprising:
driving the multiple recording heads to print a test image having a predetermined density;
reading a density of the test image; and
generating the multiple correction data based on the densities read from the test images.

14. The control method according to claim 13, wherein
when printing the test image, printing the test image by each of the multiple recording heads by driving the multiple recording heads individually,
when reading the densities of the test images, reading multiple test images formed by each of the multiple recording heads, and
when the multiple correction data are generated, generating the multiple correction data based on the densities read from each of the multiple test images.

15. The control method according to claim 13, wherein
printing the test image includes printing the test image multiple times under conditions different from each other,
reading the density of the test image includes reading the density of the test image each time the test image is printed,
generating the multiple correction data includes generating multiple sets of combinations of the multiple correction data based on multiple density reading results, and,
correcting the density unevenness includes selecting, from among multiple sets of the correction data, a combination of the multiple correction data generated under same conditions as conditions during execution of a print job.

16. The control method according to claim 13, wherein
printing the test image includes printing the test image multiple times at different times from each other,
reading the density of the test image includes reading the density of the test image each time the test image is printed,
generating of the multiple correction data includes generating multiple sets of combinations of the multiple correction data based on multiple density reading results, and
correcting the density unevenness includes selecting a combination of the multiple correction data generated under the same condition as a condition when the print job is executed from among the multiple sets of the correction data.

17. The control method according to claim 10, wherein
the multiple recording heads includes a first recording head and a second recording head,
the multiple correction data includes first correction data for equalizing density unevenness of the first recording head and second correction data for equalizing density unevenness of the second recording head, and,
the correcting density unevenness includes correcting density unevenness based on the first correction data when ink is ejected from the ejection nozzles of the first recording head and correcting density unevenness based on the second correction data when ink is ejected from the ejection nozzles of the second recording head.

18. The control method according to claim 17, further comprising:
driving the first recording head to print a first test image having a predetermined density and driving the second recording head to print a second test image having a predetermined density;
reading the respective densities of the first test image and the second test image, and,
generating the first correction data based on the density of the first test image read and generating the second correction data based on the density of the second test image read.

19. A non-transitory computer-readable recording medium having recorded thereon a program executed in an image forming apparatus in which multiple recording heads provided with multiple ejection nozzles in a main scanning direction are arranged in a partially overlap state in the main scanning direction,
the program causing the image forming apparatus to execute;
switching an ejection nozzle that ejects ink from among the multiple recording heads in an overlap region of the multiple recording heads in the main scanning direction;
storing multiple correction data for equalizing density unevenness in the main scanning direction caused by each of the multiple recording heads; and
correcting density unevenness generated in the overlap region based on the multiple correction data.
